(19) United States
(12) Patent Application Publication
(10) Pub. No.: US 2015/0331569 A1
(43) Pub. Date: Nov. 19, 2015

(54) DEVICE FOR CONTROLLING USER INTERFACE, AND METHOD OF CONTROLLING USER INTERFACE THEREOF

(71) Applicant: Electronics and Telecommunications Research Institute, Daejeon (KR)

(72) Inventors: Dong Wook KANG, Daejeon (KR); Tae Ho KIM, Gunpo-si Gyeonggi-do (KR); Chae Deok LIM, Daejeon (KR)

(21) Appl. No.: 14/620,366

(22) Filed: Feb. 12, 2015

(30) Foreign Application Priority Data
May 15, 2014 (KR) 10-2014-0058512

(51) Int. Cl. G06F 3/0484; G06F 3/0482; G06F 3/0481

(52) U.S. Cl. CPC G06F 3/0484; G06F 3/04817; G06F 3/0482

(57) ABSTRACT

Disclosed are a device for controlling a user interface, which promotes convenience for a user by adjusting a position or an arrangement of a user interface displayed on a screen, and a method of controlling a user interface thereof. A control method of a user interface controlling device includes: detecting a position of a hand of a user; determining whether a disposition of a user interface is appropriate according to the detected position of the hand; and changing a disposition of the user interface so that the user interface is positioned to be close to the detected position of the hand according to a result of the determination.

### CROSS-REFERENCE TO RELATED APPLICATIONS

This application is based on and claims priority from Korean Patent Application No. 10-2014-0058512, filed on May 15, 2014, with the Korean Intellectual Property Office, the disclosure of which is incorporated herein in its entirety by reference.

### BACKGROUND

1. Field

The present invention relates to a device for controlling a user interface, and a method of controlling a user interface thereof, and more particularly, to a device for controlling a user interface, which promotes convenience for a user by adjusting a position or an arrangement of a user interface displayed on a screen, and a method of controlling a user interface thereof.

2. Discussion of Related Art

As mobile terminals including a smart phone and a tablet Personal Computer (PC) are widely released, applications operated through the mobile terminals become various. For example, various applications providing a data and voice communication function, a function of photographing a picture or video through a camera, a voice storing function, a function of playing a music file through a speaker system, a function of displaying an image or video, and the like are mainly provided.

Along with this trend, much effort for supporting various applications of a mobile terminal and improving convenience for a user has been continuously exerted. The effort is continuously exerted for an operation method of a mobile terminal or a method of improving an operation algorithm in a software aspect, as well as a method of improving performance of a mobile terminal in a hardware aspect.

Among the methods in the software aspect, there is a method of rotating a displayed screen image according to a direction in which a mobile terminal is laid. According to the method, a mobile terminal recognizes up and down directions of the terminal or whether the terminal is rotated by using a gyro sensor or a gravity detecting sensor, and then rotates and displays a user interface displayed on a screen. However, as a screen of the mobile terminal becomes large, it is difficult for users to freely operate user interfaces laid here and there of a display screen. For example, when a user holds and operates a mobile terminal with one hand, it is difficult for the user to touch an icon of an application, which is located relatively far from the hand holding the mobile terminal, due to a physical distance between the hand and the icon. Further, even when a user uses a mobile terminal with both hands, an icon located at a center of positions of both hands is located far from both hands, so that it is difficult for the user to touch the icon.

### SUMMARY

The present invention has been made in an effort to provide a device for controlling a user interface, which improves operation convenience for a user by arranging, by a user, a position of a user interface to be close to a hand according to a position of the used hand, and a method of controlling a user interface thereof.

Further, the present invention has been made in an effort to provide a device for controlling a user interface, which promotes convenience for a user by adjusting a position or an arrangement of a user interface displayed on a screen, and a method of controlling a user interface thereof.

An exemplary embodiment of the present invention provides a control method of a user interface controlling device, including: detecting a position of a hand of a user; determining whether a disposition of a user interface is appropriate according to the detected position of the hand; and changing a disposition of the user interface so that the user interface is positioned to be close to the detected position of the hand according to a result of the determination.

The control method may further include: re-detecting a position of the hand of the user after changing the disposition of the user interface; and determining whether the re-detected position of the hand of the user is different from the previously detected position of the hand of the user according to a result of the re-detection.

The method may further include, when the re-detected position of the hand of the user is different from the previously detected position of the hand of the user, re-determining whether the changed disposition of the user interface is appropriate according to the changed position of the hand.

The changing of the disposition of the user interface may include: detecting a gravity direction of the user interface controlling device or whether the user interface controlling device is rotated; and selectively arranging the user interface in a width direction or a longitudinal direction of the user interface controlling device according to a result of the detection of the gravity direction of the user interface controlling device or whether the user interface controlling device is rotated.

The changing of the disposition of the user interface may include, when the number of detected positions of the hand is two or more, dividing the user interface into two or more groups toward the detected two or more positions of the hand and disposing the divided user interfaces.

The determining of whether the disposition of the user interface is appropriate may include, when a distance between the position of the user interface and the detected position of the hand is equal to or greater than a predetermined value, determining that the disposition of the user interface is not appropriate.

The user interface may include one or more application icons.

The detecting of the position of the hand of the user may include detecting the position of the hand of the user through a bezel surrounding a display unit of the user interface controlling device, or a peripheral part including the bezel and fixing the display unit.

The user interface controlling device may be a mobile terminal capable of transmitting or receiving data while moving.

Another exemplary embodiment of the present invention provides a device for controlling a user interface, including: a hand position detection unit configured to detect a position of a hand of a user and generate a contact signal; a controller configured to determine whether a disposition of a user interface is appropriate according to the contact signal, and generate a command for changing the disposition of the user interface so that the user interface is positioned to be close to the detected position of the hand according to a result of the determination; and a display driver configured to provide a driving signal for displaying the changed disposition of the user interface as an image according to the generated command.

The device may further include: a display unit configured to display the changed disposition of the user interface as the image according to the driving signal; and a peripheral part configured to surround or fix the display unit.

According to the exemplary embodiments of the present invention, a position of a user interface is disposed at a position close to a hand by detecting a position of the hand of the user, thereby improving convenience when the user operates the user interface.

Further, there are provided the user interface controlling device capable of freely adjusting a position or an arrangement of a user interface according to a position of a hand of a user, and the method of controlling a user interface of the user interface controlling device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a top plan view illustrating an example of a user interface controlling device according to an exemplary embodiment of the present invention;

FIGS. 2A and 2B are top plan views illustrating an example of a method of re-arranging a user interface by detecting a position of a hand of a user according to an exemplary embodiment of the present invention;

FIGS. 3A and 3B are top plan views illustrating an example of a method of re-arranging a user interface by detecting a position of a hand of a user according to another exemplary embodiment of the present invention;

FIGS. 4A to 4C are top plan views illustrating an example of a method of detecting a position of a hand of a user through a camera by the user interface controlling device of the present invention;

FIG. 5 is a block diagram schematically illustrating an example of the user interface controlling device according to the exemplary embodiment of the present invention;

FIG. 6 is a diagram for particularly describing a method of operating a user interface controlling device in stages according to an exemplary embodiment of the present invention;

FIG. 7 is a flowchart illustrating an example of a user interface controlling method according to an exemplary embodiment of the present invention; and

FIG. 8 is a flowchart illustrating an example of a user interface controlling method according to another exemplary embodiment of the present invention.

### DETAILED DESCRIPTION

The present invention will be described with reference to the accompanying drawings based on a specific embodiment in which the present invention may be carried out as an example. It should be understood that various embodiments of the present invention are different from each other, but need not to be mutually exclusive. For example, a specific figure, a structure, and a characteristic described herein may be implemented as another embodiment without departing from a spirit and a scope of the present invention in relation to an embodiment.

Further, it should be understood that a position or a displacement of an individual constituent element in each disclosed embodiment may be changed without departing from the spirit and the scope of the present invention. Accordingly, the detailed description below is not intended as a limit meaning, and the scope of the present invention is defined by the accompanying claims in principle, and includes the matters described in the claims and exemplary embodiments within an equivalent scope thereto. When like reference numerals are used in the drawings, the like reference numerals denote the same or similar functions in several exemplary embodiments.

Hereinafter, contents and a spirit of the present invention will be described through a particular exemplary embodiment with reference to the accompanying drawings.

FIG. 1 is a top plan view illustrating an example of a user interface controlling device according to an exemplary embodiment of the present invention. Referring to FIG. 1, a user interface controlling device 100 includes a peripheral part 110 including a bezel, and a display unit 120 for displaying a user interface.

The user interface controlling device 100 is a device for generating, displaying, and arranging a user interface, and receiving and processing an input of a user for the user interface, and may include a mobile terminal, such as a mobile phone, a smart phone, a notebook computer, a tablet PC, Personal Digital Assistance (PDA), a Portable Multimedia Player (PMP), and a navigation device.

The display unit 120 is a module for displaying a user interface 130, and includes one or more image display means. For example, the display unit 130 may include at least one of displays means well known in the art, such as a Liquid Crystal Display (LCD), a Thin Film Transistor-Liquid Crystal Display (TFT LCD), an Organic Light-Emitting Diode (OLED) display, a flexible display, and a hologram.

The display unit 120 displays a user interface 130 on a screen thereof.

The user interface 130 includes one or more applications (hereinafter, referred to as an “app”) icons. The app icons included in the user interface 130 may be related to various applications having different functions. For example, the app icons may be icons indicating apps having various functions, such as a weather report app, an email app, an Internet search app, a video play app, a call app, a recording device app, a camera app, an image management app, and a translation app.

The peripheral part 110 is a peripheral structure which is combined with the display unit 120 so as to surround the display unit 120, and fix the display unit 120. The peripheral unit 110 includes a bezel part for fixing the display unit 120. The peripheral part 110 includes sensors (not shown) for detecting a touch of a user therein, or is combined with the sensors to detect a contact of a user and a contact position for the user interface controlling device 100. A result of the detection of the contact of the user and the contact position is transmitted to a controller (not shown) or a Central Processing Unit (CPU) of the user interface controlling device 100 to be referred for adjusting a position or an arrangement of the user interface 130.

In the present invention, when a hand of a user is in contact with the peripheral unit 110, the user interface controlling device 100 detects a position of the contact and determines whether the hand is far from the user interface 130. Further, when the hand is far from the user interface 130, the user interface controlling device 100 moves the user interface 130 to a position close to the hand to enable the user to more easily operate the user interface 130.

As an exemplary embodiment, when the user interface controlling device 100 changes a position of the user interface 130, the user interface controlling device 100 may change an arrangement order and form of the app icons of the user interface 130. For example, even though the user interface 130 has an icon arrangement form including four rows and four columns (that is, 4×4) before the movement, the user interface controlling device 100 may change an arrangement order and form of the app icons so that the user interface 130 has an icon arrangement form of two rows and eight columns (that is, 2×8) after the movement if necessary for improving convenience for the user according to the detected position of the hand.

According to the aforementioned configuration of the present invention, the user interface controlling device 100 detects a position of a hand of a user and disposes the position of the user interface to be close to the hand, thereby improving convenience for a user when the user operates the user interface.

Further, there is provided a particular idea for the user interface controlling device capable of freely adjusting a position or an arrangement of a user interface according to a position of a hand of a user.

Hereinafter, the configuration and an operation method of the present invention will be described in detail with reference to more particularly described exemplary embodiments and drawings.

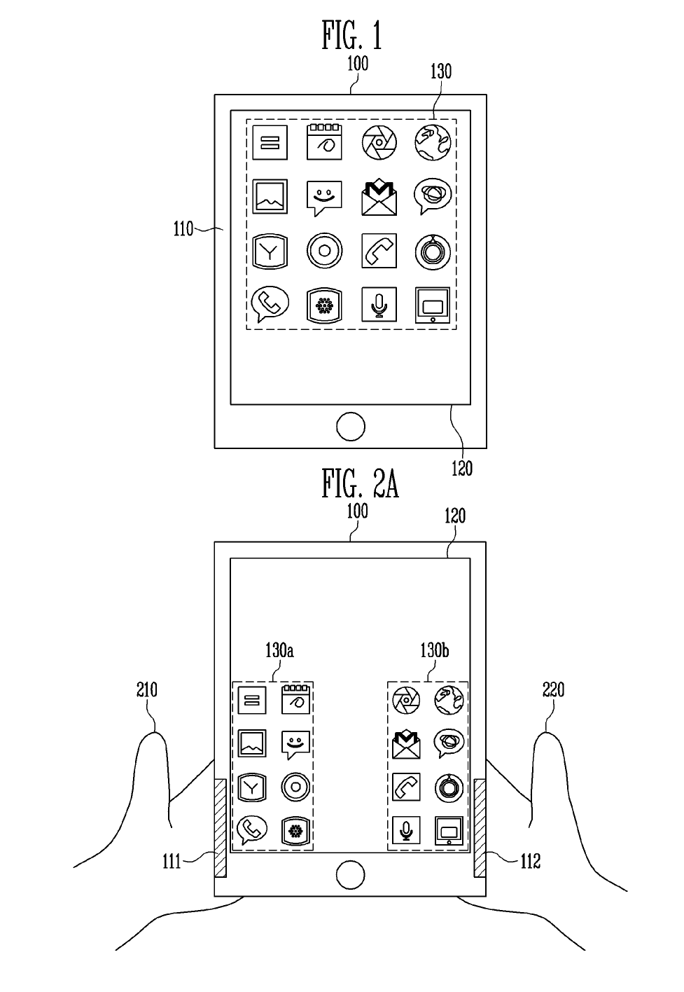

FIGS. 2A and 2B are top plan views illustrating an example of a method of re-arranging a user interface by detecting a position of a hand of a user according to an exemplary embodiment of the present invention. FIGS. 2A and 2B illustrate an exemplary embodiment in which a user operates the user interface controlling device 100 by using two hands. Among them, FIG. 2A illustrates the case where a user holds the user interface controlling device 100 in a vertical direction (or a longitudinal direction) and operates the user interface controlling device 100, and FIG. 2B illustrates the case where a user holds the user interface controlling device 100 in a horizontal direction (or a width direction) and operates the user interface controlling device 100.

Referring to FIG. 2A, a user holds the user interface controlling device 100 with his/her both hands 210 and 220. The user interface controlling device 100 detects whether both hands 210 and 220 of the user are in contact with the peripheral part 110 and positions of the contact. In this case, the user interface controlling device 100 detects whether the user is in contact with the peripheral part 110 and a position of the contact by using the sensors embedded in the peripheral part 100 or combined with the peripheral part 110.

Further, the user interface controlling device 100 moves or re-arranges the user interface according to the detected position of the contact. For example, when both hands of the user are in contact with two different positions 111 and 112 as illustrated in FIG. 2A, the user interface controlling device 100 may detect the contacts of both hands, divide the user interface 130 (see FIG. 1) into two parts, and separately divide the divided user interfaces toward both hands of the user, respectively. That is, one 130a of the divided user interfaces may be disposed at a position close to the left hand of the user, and the other one 130b of the divided user interfaces may be disposed at a position close to the right hand of the user.

In the meantime, in this case, the user holds the user interface controlling device 100 in the vertical direction, so that the user interfaces 130a and 130b are arranged in the vertical direction for operation convenience and watching convenience for the user.

Referring to FIG. 2B, the user holds the user interface controlling device 100 with his/her both hands 210 and 220 similar to FIG. 2A. The user interface controlling device 100 detects whether both hands 210 and 220 of the user are in contact with the peripheral part 110 and positions of the contacts.

However, the user holds the user interface controlling device 100 in a horizontal direction in FIG. 2B, which is different from FIG. 2A. Accordingly, in consideration of operation convenience and watching convenience for the user, the user interfaces 130a and 13b are arranged in the horizontal direction. Except for the arrangement of the user interfaces 130a and 130b in the horizontal direction, the configuration and the operation method of the user interface controlling device 100 are the same as those of FIG. 2A.

In the meantime, the case where the user interface is divided into two parts and the divided user interfaces are re-arranged is a simple example, and the user interface controlling device 100 does not need to be essentially limited to the aforementioned configuration. For example, the user interface controlling device 100 may change the position of the user interface 130 to a center point of the positions of both hands of the user, instead of the division of the user interface 130 into two parts.

As an exemplary embodiment, whether the user holds the user interface controlling device 100 in the vertical direction or the horizontal direction may be determined by using a gyro sensor (not shown), which is embedded in the user interface controlling device 100 and detects whether the user interface controlling device 100 is rotated or a rotation direction of the user interface controlling device 100, or a gravity detecting sensor (not shown) for detecting a direction of gravity.

According to the aforementioned configuration, a user interface control method when the user holds and operates the user interface controlling device 100 with his/her both hands is appropriately provided. In this case, the divided and re-arranged user interfaces 130a and 130b are located to be close to both hands of the user, so that the user may more easily touch and operate the user interfaces 130a and 130b.

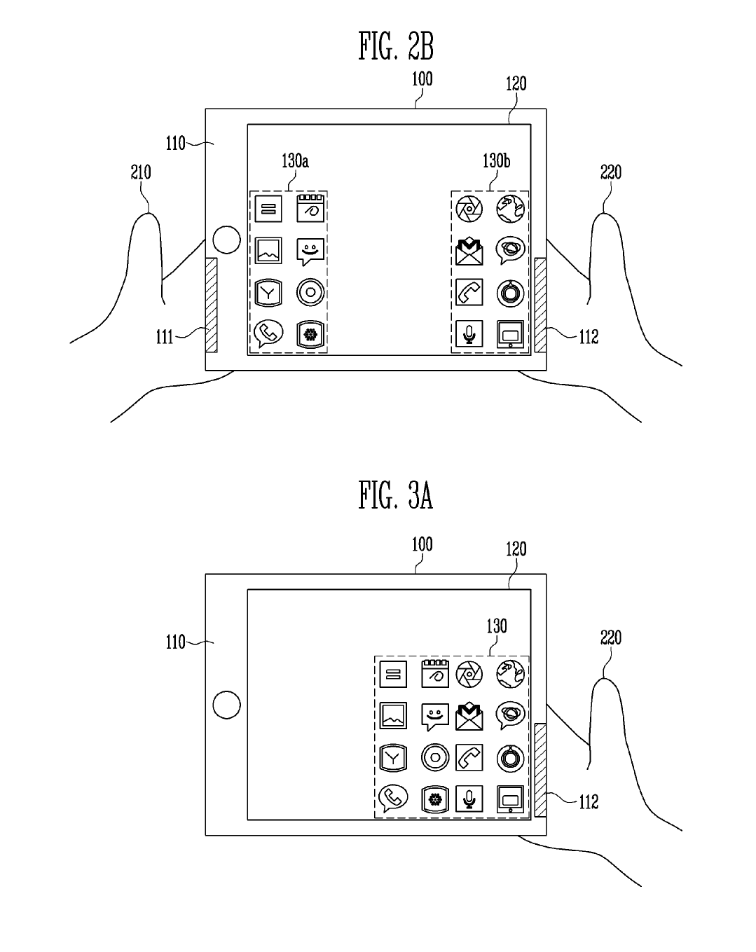

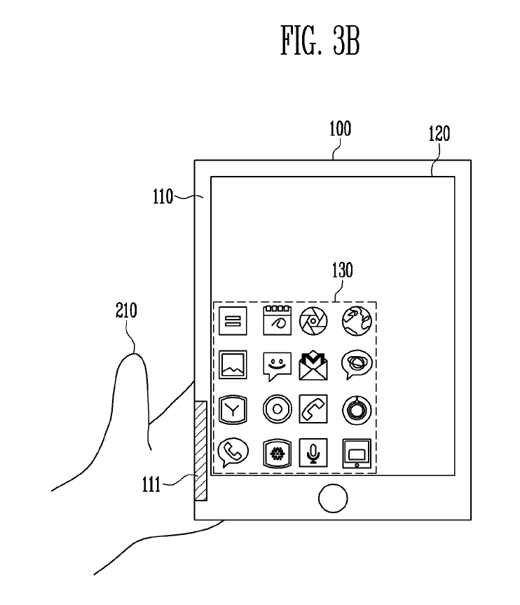

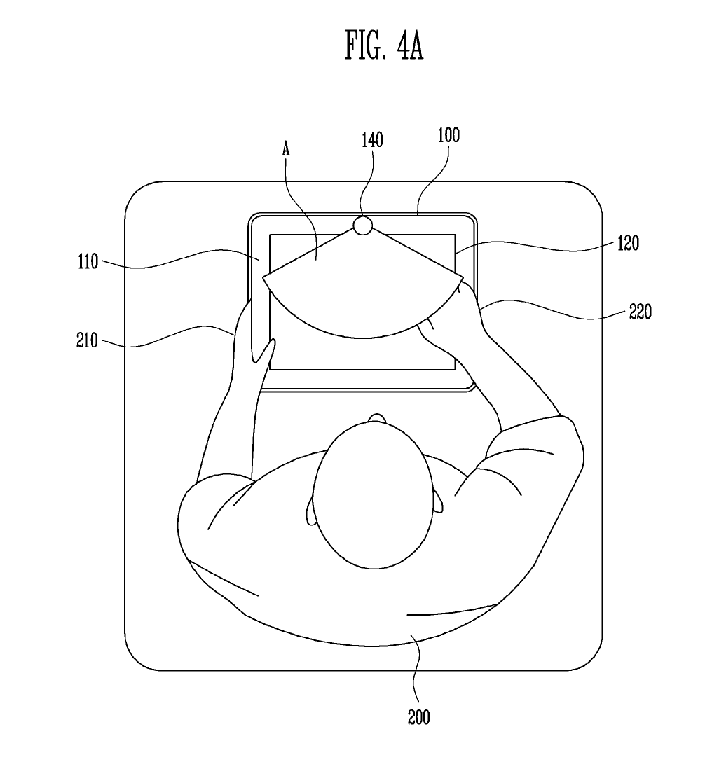

FIGS. 3A and 3B are top plan views illustrating an example of a method of re-arranging a user interface by detecting a position of a hand of a user according to another exemplary embodiment of the present invention. FIGS. 3A and 3B illustrate an exemplary embodiment in which a user operates the user interface controlling device 100 by using one hand. Among them, FIG. 3A illustrates the case where the user holds the user interface controlling device 100 in a horizontal direction and operates the user interface controlling device 100, and FIG. 3B illustrates the case where a user holds the user interface controlling device 100 in a vertical direction and operates the user interface controlling device 100.

Referring to FIG. 3A, the user holds the user interface controlling device 100 with his/her right hand 220. The user interface controlling device 100 detects whether the right hand 220 of the user is in contact with the peripheral part 110 or a position of the contact. In this case, the user interface controlling device 100 detects whether the user is in contact with the peripheral part 110 and a position of the contact by using the sensors embedded in the peripheral part 100 or combined with the peripheral part 110.

Further, the user interface controlling device 100 moves or re-arranges the user interface according to the detected position of the contact. For example, when the right hand 220 of the user holds one side of the user interface controlling device 100, the user interface controlling device 100 detects a contact position 112, and moves and arranges the user interface 130 to a position around the contact position 112 at which the right hand 220 of the user is contact with the user interface controlling device 100.

In the meantime, in this case, the user holds the user interface controlling device 100 in the horizontal direction, so that the user interfaces 130a and 130b are arranged in the horizontal direction for operation convenience and watching convenience for the user.

Referring to FIG. 3B, the user holds the user interface controlling device 100 with his/her one hand 210 similar to FIG. 3A. However, the fact that the user holds the user interface controlling device 100 with the opposite hand (that is, the left hand 210) in the vertical direction is different from FIG. 3A.

Similar to FIG. 3A, the user interface controlling device 100 detects whether the left hand 210 of the user is in contact with the peripheral part 110 or a position of the contact. Further, when the user interface controlling device 100 detects that the left hand 210 of the user is in contact with the peripheral part 110 at a contact position 111, the user interface controlling device 100 moves and arranges the user interface 130 in a position around the contact position 111.

In this case, the user holds the user interface controlling device 100 in the vertical direction, so that the user interface controlling device 100 arranges the user interface 130 in the vertical direction for operation convenience and watching convenience for the user. Except for the arrangement of the user interface 130 in the vertical direction, the configuration and the operation method of the user interface controlling device 100 are the same as those of FIG. 3A.

As an exemplary embodiment, whether the user holds the user interface controlling device 100 in the vertical direction or the horizontal direction may be determined by using a gyro sensor (not shown), which is embedded in the user interface controlling device 100 and detects whether the user interface controlling device 100 is rotated or a rotation direction of the user interface controlling device 100, or a gravity detecting sensor (not shown) for detecting a direction of gravity.

According to the aforementioned configuration, the user interface control method when the user holds and operates the user interface controlling device 100 with his/her one hand is appropriately provided.

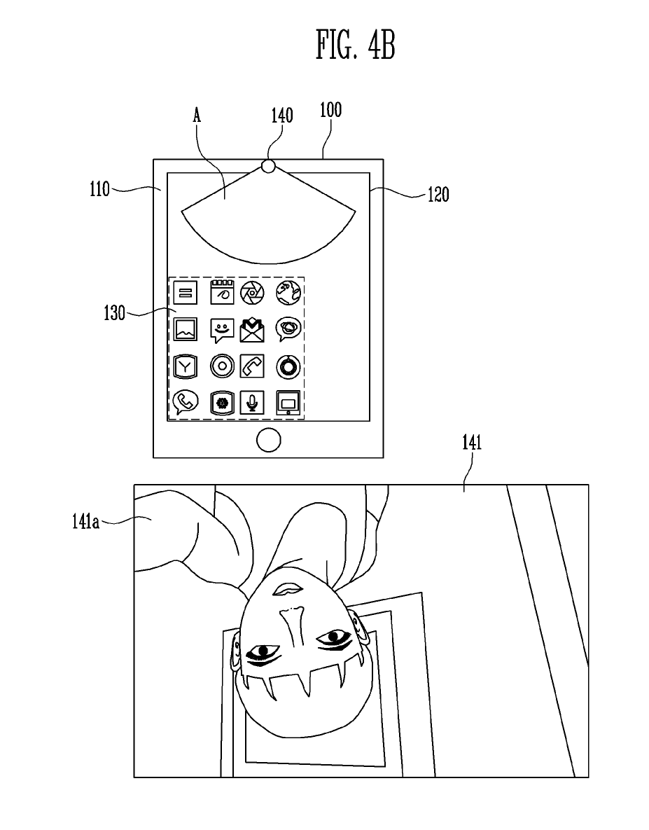

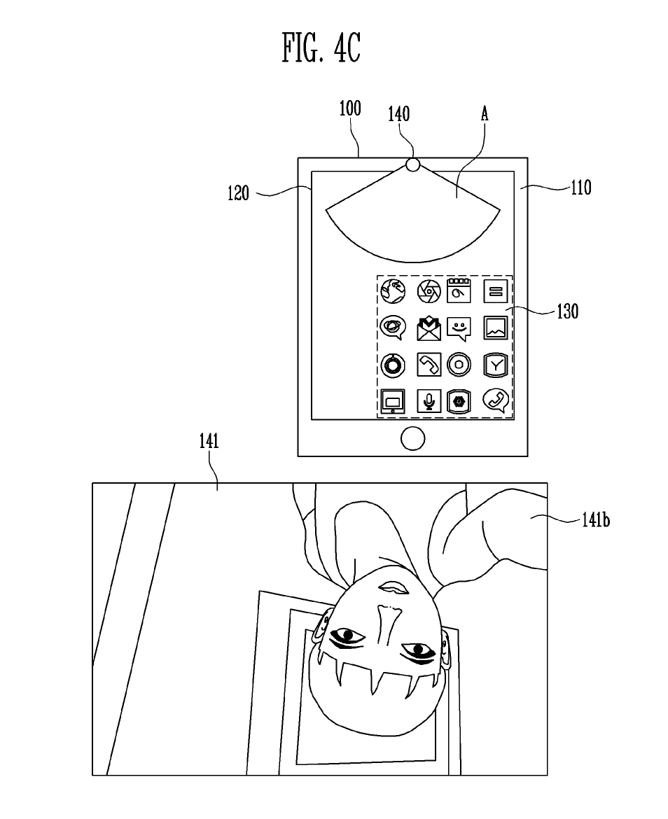

FIGS. 4A to 4C are top plan views illustrating an example of a method of detecting a position of a hand of a user through a camera by the device for controlling a user interface of the present invention.

Referring to FIGS. 4A to 4C, the user interface controlling device 100 may determine a position of a hand of a user from a photographed image of a part of or the entire body of the user 200 obtained through the camera 140, instead of or in addition to the detection of a contact of the hand with the peripheral part 110 and the determination of the position of the hand of the user.

Referring to FIG. 4A, the user interface controlling device 100 includes the peripheral unit 110 and the display unit 120 similar to FIGS. 1 to 3B, and further includes a camera 140 for photographing the body of the user (for example, the hands 210 and 220 of the user).

The user interface controlling device 100 photographs an image of the hands 210 and 220 of the user through the camera 140. Further, the user interface controlling device 100 determines relative positions (that is, relative positions with respect to the user interface controlling device 100) of the hands of the user from the photographed image of the hands.

For example, when the right hand 220 of the user is photographed through the camera 140, the user interface controlling device 100 determines that the right hand 220 of the user is located to be close to the user interface controlling device 100 (for example, for an operation of the user interface controlling device 100). Further, by the same method as that described with reference to FIG. 3A, the user interface controlling device 100 moves and arranges the user interface 130 in a position around the right hand 220 of the user. Otherwise, when the left hand 210 of the user is photographed through the camera 140, the user interface controlling device 100 determines that the left hand 210 of the user is located to be close to the user interface controlling device 100. Further, by the same method as that described with reference to FIG. 3B, the user interface controlling device 100 moves and arranges the user interface 130 in a position around the left hand 210 of the user. Similarly, when all of the left and right hands 210 and 220 of the user are photographed through the camera 140, the user interface controlling device 100 determines that all of the left and right hands 210 and 220 of the user are located to be close to the user interface controlling device 100. Further, by the same method as that described with reference to FIG. 2A, the user interface controlling device 100 divides the user interface 130 and moves and arranges the divided user interfaces 130 in positions around the left and right hands 210 and 220.

As an exemplary embodiment, the camera 140 may be a camera having a predetermined viewing angle (A), and in this case, the camera 140 may photograph the body of the user located within the viewing angle (A), and determine the position of the user from the photographed image of the body of the user. In this case, the photographed image of the body of the user needs not to essentially be the image of the hands 210 and 220 of the user. For example, even when the photographed image of the body of the user is a left shoulder, a left elbow, or a left wrist of the user, the user interface controlling device 100 may determine that the left hand 210 of the user is positioned to be close to the user interface controlling device 100 from the photographed image of the body of the user, and move and arrange the user interface 130 in a position around the left hand 210 of the user.

A particular example of the method is suggested in FIGS. 4A and 4C.

FIG. 4B is a top plan view illustrating a method of determining a position of a hand of the user through the camera 140 when the user holds the user interface controlling device 100 with the left hand. Referring to FIG. 4B, the camera 140 photographs only a part of the body of the user, and a photographed image 141 does not include the left hand of the user due to a limited viewing angle (A). Instead, the photographed image 141 includes a part 141a (a left forearm of the user) of the body of the user related to the left hand of the user.

In this case, the user interface 130 determines that the photographed image is related to the left hand of the user from the photographed part 141a of the body of the user, determines a position of the photographed part 141a of the body of the user or a position of the left hand of the user estimated from the position of the photographed part 141a of the body of the user, and then moves and arranges the user interface 130 in a position around the determined position.

For example, when it is assumed that the image 141 illustrated in FIG. 4B is a reversed image, the left forearm 141a of the user is located at a left-upper end of the image 141. This means that a relative position of the left forearm 141a is a left-lower end of the user interface controlling device 100 (because the image 141 is the reversed image). In the meantime, it is obvious that the left hand of the user is positioned around the left forearm 141a according to a body structure of the user, so that the user interface controlling device 100 determines that the left hand of the user is positioned at a left-lower end of the user interface controlling device 100 from the photographed image 141. Further, the user interface controlling device 100 moves and arranges the user interface 130 in a left-lower end of the display 120.

FIG. 4B is a top plan view illustrating a method of determining a position of a hand of the user through the camera 140 when the user holds the user interface controlling device 100 with the right hand. Referring to FIG. 4C, the camera 140 photographs only a part of the body of the user, and a photographed image 141 does not include the right hand of the user due to a limited viewing angle (A). Instead, the photographed image 141 includes a part 141b (a right forearm of the user) of the body of the user related to the right hand of the user.

In FIG. 4C, the user interface 130 determines that the photographed image is related to the right hand of the user from the photographed part 141b of the body of the user, determines a position of the photographed part 141b of the body of the user or a position of the right hand of the user estimated from the position of the photographed part 141b of the body of the user, and then moves and arranges the user interface 130 in a position around the determined position, by the same method as that of FIG. 4B.

In this case, when it is assumed that the illustrated image 141 is a reversed image similar to FIG. 4B, a relative position of the right forearm 141b of the user and the right hand estimated from the position of the right forearm 141b of the user is recognized as a right-lower end of the user interface controlling device 100, so that the user interface controlling device 100 moves and arranges the user interface 130 in a right-lower end of the display 120.

According to the methods described with reference to FIGS. 4A to 4C, the user interface controlling device 100 may detect a position of the hand of the user 200 even through the camera 140 of the user interface controlling device 100, and appropriately move and arrange the user interface 130.

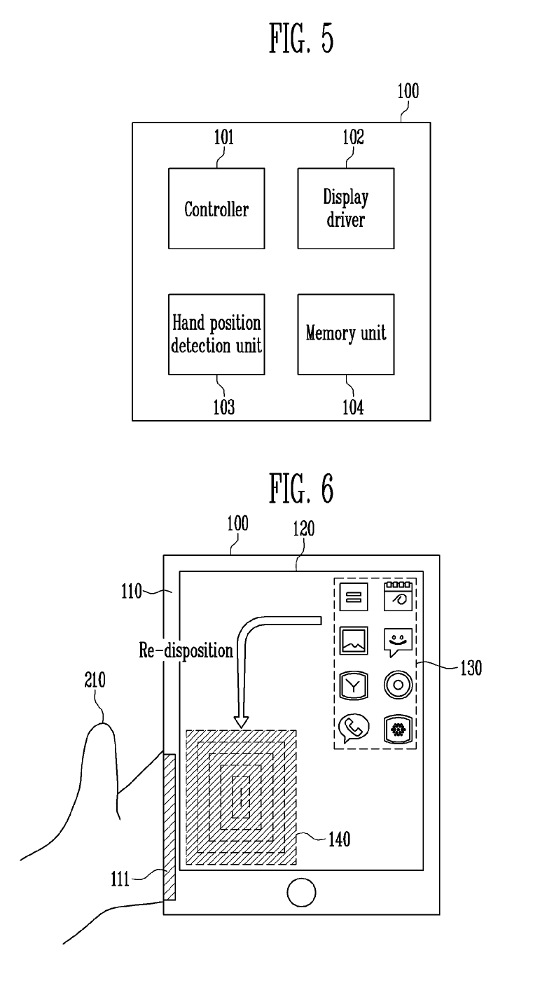

FIG. 5 is a block diagram schematically illustrating an example of a configuration of the device for controlling a user interface according to the exemplary embodiment of the present invention. Referring to FIG. 5, the user interface controlling device 100 includes a controller 101, a display driver 102, a hand position detection unit 103, and a memory unit 104.

The controller 101 controls a general operation of the user interface controlling device 100, and performs necessary computing calculation for generation, movement, change, disposition, arrangement, or deletion of the user interface 130 (see FIG. 1). For example, the controller 101 receives a contact signal including information on contact positions of the user (for example, the positions of the hands of the user determined or estimated from the contact positions 111 and 112 of FIG. 2A or the image 141 of FIGS. 4B and 4C) through the hand position detection unit 103, and moves the position of the user interface 130 or provides the display driver 102 with a command for changing the arrangement of the user interface 130 and displaying the changed user interface 130 according to the received contact signal.

For example, when the current user interface 130 is positioned at a position close to the detected contact position of the user, the controller 101 does not provide a separate position movement command or arrangement change command. However, when the current user interface 130 is positioned at a position far from the detected contact position of the user, the controller 101 provides a position movement command or an arrangement change command for adjusting the position of the user interface 130 so as to be close to the contact position of the user.

The display driver 102 provides the display unit 120 (see FIG. 1) with a driving signal for displaying an image according to an image display command provided from the controller 101. For example, the display driver 102 provides the display unit 120 with the driving signal for moving or changing and displaying the user interface 130 in response to the position movement command or the arrangement change command of the controller 101. As an exemplary embodiment, the display driver 102 may include a driving circuit of the display unit 120.

The hand position detection unit 103 receives a contact signal of the user from the peripheral unit 110 (see FIG. 1) or the sensors combined with the peripheral unit 110, processes the received contact signal into a digital signal, and provides the controller 101 with the processed digital signal. The contact signal provided by the hand position detection unit 103 includes information on the contact position of the user, coordinates of the contact, or the number of contact points of the user.

As an exemplary embodiment, as illustrated in FIGS. 4A to 4C, the hand position detection unit 103 may detect or determines the position of the hand of the user from the image photographed by the camera 140 (see FIG. 4A), process the detected or determined position of the hand of the user into a digital signal, and provide the controller 101 with the processed digital signal as the contact signal.

The memory unit 104 stores reference information used for providing the position movement command or the arrangement change command by referring to the contact signal, and provides the controller 101 with the stored reference information according to a request. For example, the memory unit 104 may store information indicating a current position of the user interface 130, and provide the controller 101 with the stored information in response to the request of the controller 101.

According to the aforementioned configuration, the schematic module configuration of the user interface controlling device 100 is provided. In the meantime, the user interface controlling device 100 may further include configurations, which may be generally included in a mobile terminal and well known in the art, in addition to the aforementioned controller 101, display driver 102, hand position detection unit 103, and memory unit 104.

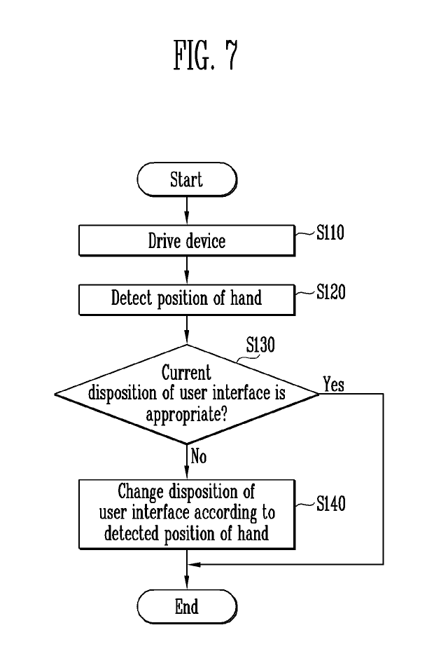

FIG. 6 is a diagram for particularly describing a method of operating the device for controlling a user interface in stages according to an exemplary embodiment of the present invention.

In FIG. 6, it is illustrated that the user interface 130 includes the less number of app icons than those of FIGS. 1 to 3B, but this is for simplicity and readability of the drawing, and does not intend to influence the contents of the invention or illustrate a different exemplary embodiment.

In FIG. 6, the technical contents identical or similar to those described with reference to FIGS. 1 to 3B are described. However, the resulting function and the effect of the user interface controlling device 100 have been mainly described in the aforementioned drawings, but in FIG. 6, particular operation steps for achieving the function and the effect will be described.

In FIG. 6, it is assumed that the interface 130 is displayed with icons in a form of 4×2 at a right-upper end of the display unit 120. When the left hand 210 of the user is in contact with the right and lower end position 111 of the peripheral part 110, the peripheral part 110 detects the contact position through the sensor (not shown) embedded in the peripheral unit 110 or combined with the peripheral unit 110.

Otherwise, the user interface controlling device 100 determines or estimates the position of the hand of the user from the image photographed through the camera 140 (see FIG. 4A), instead of or in addition to the method of detecting the position of the hand of the user by using the contact sensor, and detects or determines the contact position 111 of the hand 210 of the user from the determined or estimated position of the hand of the user (see FIGS. 4A to 4C).

Further, the user interface controlling device 100 determines whether the contact position 111 is far from the position at which the user interface 130 is displayed. For example, when an interval between the contact position 111 and the user interface 130 is a predetermined distance or more, the user interface controlling device 100 determines that the contact position 111 is far from the user interface 130. By contrast, when the interval between the contact position 111 and the user interface 130 is less than the predetermined distance, the user interface controlling device 100 determines that the contact position 111 is not far from the user interface 130.

As a result of the determination, when the user interface 130 is far from the contact position 111, the user interface controlling device 100 moves the position of the user interface 130 to be close to the contact position 111.

As an exemplary embodiment, the user interface controlling device 100 may first determine or fixe a region to which the user interface 130 is to be moved, and re-arrange the app icons of the user interface 130 within the determined or fixed region (for example, reference numeral 140 of FIG. 6).

As an exemplary embodiment, the user interface controlling device 100 may periodically check whether the user is in contact with the peripheral part 110 and a contact position, and periodically adjust the position of the user interface 130 according to the periodical check.

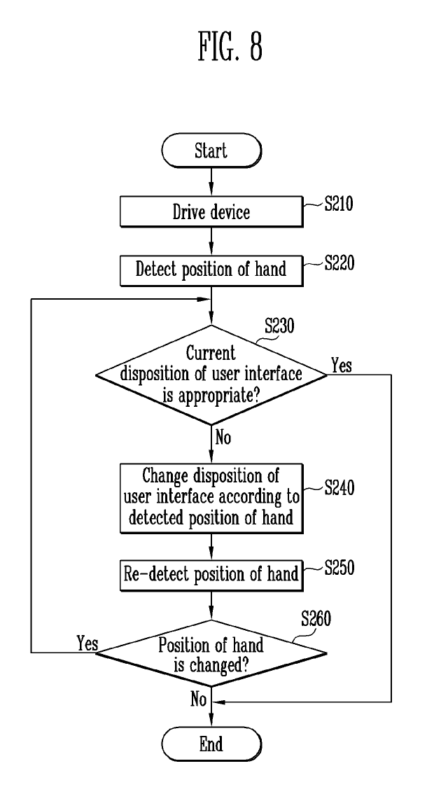

FIG. 7 is a flowchart illustrating an example of a method of controlling a user interface according to an exemplary embodiment of the present invention. Referring to FIG. 7, the method of controlling a user interface includes operation S110 to operation S140.

In operation S110, the user interface controlling device 100 (see FIG. 1) is driven. A meaning of the driving in this case does not refer to only new power-on and initial driving of the user interface controlling device 100. For example, the driving includes a meaning collectively including general operation events of the user interface controlling device, such as returning to hibernation, an operation of an application, returning to a main screen image after the end of the application, and user touch recognition, as well as initial driving.

In operation S120, the user interface controlling device 100 detects a position of a contact hand (or a contact position) of the user. As an exemplary embodiment, the user interface controlling device 100 may detect whether the user is in contact with the peripheral part 110 or the position of the contact hand of the user through the sensor embedded in the peripheral part 110 (see FIG. 1) or combined with the peripheral part 110.

Otherwise, the user interface controlling device 100 determines or estimates the position of the hand of the user from an image photographed through the camera 140 (see FIG. 4A), instead of or in addition to the method of detecting the position of the hand by using contact sensor, and detects or determines the contact position of the hand of the user from the determined or estimated position of the hand of the user (see FIGS. 4A to 4C).

In operation S130, the user interface controlling device 100 determines whether a current disposition (for example, a position or an arrangement) of the user interface is appropriate by referring to the detected position of the hand. For example, when the position of the current user interface is far from the detected position of the hand, the user interface controlling device 100 determines that the current disposition of the user interface is not appropriate. By contrast, when the position of the current user interface is not far from the detected position of the hand, the user interface controlling device 100 determines that the current disposition of the user interface is appropriate.

When the current disposition of the user interface is appropriate, the method of controlling the user interface is terminated. Otherwise, the method of controlling the user interface proceeds to operation S140.

In operation S140, the user interface controlling device 100 changes the arrangement (for example, the position or the arrangement) of the user interface according to the detected position of the hand. For example, the user interface controlling device 100 moves the position of the user interface so as to be close to the detected position of the hand. Further, the user interface controlling device 100 may move the position of the user interface, and may further change an arrangement order and an arrangement form of the icons within the user interface if necessary for improving convenience for the user.

According to the aforementioned configuration of the present invention, the user interface controlling device 100 detects a position of a hand of a user and disposes the position of the user interface to be close to the hand, thereby improving convenience for a user when the user operates the user interface.

Further, there is provided a particular idea for the method of controlling a user interface, which is capable of freely adjusting a position or an arrangement of a user interface according to a position of a hand of a user.

FIG. 8 is a flowchart illustrating an example of a method of controlling a user interface according to another exemplary embodiment of the present invention. Referring to FIG. 8, the method of controlling a user interface includes operation S120 to operation S260.

Operations 5210 to 5240 of the method of controlling a user interface of FIG. 8 are substantially the same as operations S110 to S140 of FIG. 7. However, the method of controlling a user interface of FIG. 8 further includes operations S250 and S260.

In operation 5210, the user interface controlling device 100 (see FIG. 1) is driven. A meaning of the driving in this case does not refer to only new power-on and initial driving of the user interface controlling device 100. For example, the driving includes a meaning collectively including general operation events of the user interface controlling device, such as returning to hibernation, an operation of an application, returning to a main screen image after the end of the application, and user touch recognition, as well as initial driving.

In operation S120, the user interface controlling device 100 detects a position of a contact hand (or a contact position) of the user. As an exemplary embodiment, the user interface controlling device 100 may detect whether the user is in contact with the peripheral part 110 or the position of the contact hand of the user through the sensor embedded in the peripheral part 110 (see FIG. 1) or combined with the peripheral part 110.

Otherwise, the user interface controlling device 100 determines or estimates the position of the hand of the user from an image photographed through the camera 140 (see FIG. 4A), instead of or in addition to the method of detecting the position of the hand by using contact sensor, and detects or determines the contact position of the hand of the user from the determined or estimated position of the hand of the user (see FIGS. 4A to 4C).

In operation S230, the user interface controlling device 100 determines whether a current disposition of the user interface is appropriate by referring to the detected position of the hand. For example, when the position of the current user interface is far from the detected position of the hand, the user interface controlling device 100 determines that the current disposition of the user interface is not appropriate. By contrast, when the position of the current user interface is not far from the detected position of the hand, the user interface controlling device 100 determines that the current disposition of the user interface is appropriate.

When the current disposition of the user interface is appropriate, the method of controlling the user interface is terminated. Otherwise, the method of controlling the user interface proceeds to operation 5240.

In operation S140, the user interface controlling device 100 changes the disposition, the position, or the arrangement of the user interface according to the detected position of the hand. For example, the user interface controlling device 100 moves the position of the user interface so as to be close to the detected position of the hand. Further, the user interface controlling device 100 may move the position of the user interface, and may further change an arrangement order and an arrangement form of the icons within the user interface if necessary for improving convenience for the user.

In operation S250, the user interface controlling device 100 detects a position of the hand of the user again. As an exemplary embodiment, the user interface controlling device 100 may detect whether the user is in contact with the peripheral part 110 or the position of the contact hand of the user by the same method as that of operation S220 through the sensor.

In operation S260, the user interface controlling device 100 determines whether the re-detected position of the hand is changed. Particularly, when the re-detected position of the user is different from the previously detected position of the hand of the user, the method of controlling a user interface returns to operation S230. Further, according to a result of the determination on whether the re-detected position of the user is changed, the method of controlling a user interface returns to operation S230, and repeatedly performs the adjustment operations S230 to S260. In the meantime, when the re-detected position of the user is the same as the previously detected position of the hand of the user, the method of controlling a user interface is terminated.

In the meantime, in FIG. 8, it is illustrated that when the position of the hand is re-detected and the re-detected position of the hand is not changed, the method of controlling a user interface is terminated, but the scope of the present invention is not limited thereto. For example, the method of controlling a user interface may be configured so that the position of the hand of the user is repeatedly or periodically re-detected, and operations S230 to S260 are continuously and repeatedly performed according to the detected position of the hand. That is, operations S250 and S260 are not once and intermittently performed, but may be repeatedly and continuously performed.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A control method of a user interface controlling device, comprising:
detecting a position of a hand of a user;
determining whether a disposition of a user interface is appropriate according to the detected position of the hand; and
changing a disposition of the user interface so that the user interface is positioned to be close to the detected position of the hand according to a result of the determination.

2. The control method of claim 1, further comprising:
re-detecting a position of the hand of the user after changing the disposition of the user interface; and
determining whether the re-detected position of the hand of the user is different from the previously detected position of the hand of the user according to a result of the re-detection.

3. The control method of claim 2, further comprising:
when the re-detected position of the hand of the user is different from the previously detected position of the hand of the user, re-determining whether the changed disposition of the user interface is appropriate according to the changed position of the hand.

4. The control method of claim 1, wherein the changing of the disposition of the user interface includes:
detecting a gravity direction of the user interface controlling device or whether the user interface controlling device is rotated; and
selectively arranging the user interface in a width direction or a longitudinal direction of the user interface controlling device according to a result of the detection of the gravity direction of the user interface controlling device or whether the user interface controlling device is rotated.

5. The control method of claim 1, wherein the changing of the disposition of the user interface includes, when the number of detected positions of the hand is two or more, dividing the user interface into two or more groups toward the detected two or more positions of the hand and disposing the divided user interfaces.

6. The control method of claim 1, wherein the determining of whether the disposition of the user interface is appropriate includes, when a distance between the position of the user interface and the detected position of the hand is equal to or greater than a predetermined value, determining that the disposition of the user interface is not appropriate.

7. The control method of claim 1, wherein the user interface includes one or more application icons.

8. The control method of claim 1, wherein the detecting of the position of the hand of the user includes detecting the position of the hand of the user through a bezel surrounding a display unit of the user interface controlling device, or a peripheral part including the bezel and fixing the display unit.

9. The control method of claim 1, wherein the detecting of the position of the hand of the user includes:
photographing at least a part of a body of the user through a camera included in the user interface controlling device; and
determining or detecting the position of the hand of the user from the photographed image of at least a part of the body of the user.

10. The control method of claim 1, wherein the user interface controlling device is a mobile terminal capable of transmitting or receiving data while moving.

11. A device for controlling a user interface, comprising:
a hand position detection unit configured to detect a position of a hand of a user and generate a contact signal;
a controller configured to determine whether a disposition of a user interface is appropriate according to the contact signal, and generate a command for changing the disposition of the user interface so that the user interface is positioned to be close to the detected position of the hand according to a result of the determination; and
a display driver configured to provide a driving signal for displaying the changed disposition of the user interface as an image according to the generated command.

12. The device of claim 11, further comprising:
a display unit configured to display the changed disposition of the user interface as the image according to the driving signal; and
a peripheral part configured to surround or fix the display unit.
